(19) United States
(12) Patent Application Publication
(10) Pub. No.: US 2007/0099648 A1
(43) Pub. Date: May 3, 2007

(54) Apparatus and method for controlling uplink load in a wireless communication system

(75) Inventors: Yong-Seok Kim, Suwon-si (KR); Young-Hoon Kwon, Seongnam-si (KR); Soon-Young Yoon, Seoul (KR)

Correspondence Address: THE FARRELL LAW FIRM, 333 EARLE OVINGTON BOULEVARD., SUITE 701, UNIONDALE, NY, 11553, US

(73) Assignee: SAMSUNG ELECTRONICS CO., LTD., Suwon-si (KR)

(21) Appl. No.: 11/592,278

(22) Filed: Nov. 2, 2006

(30) Foreign Application Priority Data
Nov. 2, 2005 (KR) 104550-2005

(51) Int. Cl. H04B 7/00; H04B 1/00

(52) U.S. Cl. 455/522; 455/69

(57) ABSTRACT

A method is provided for controlling uplink power in a wireless communication system. The method includes receiving downlink channel information from a mobile station (MS); measuring uplink channel information of the MS; selecting channel information having a lower value from among the forward channel information and the uplink channel information; determining a power level and a Modulation and Coding Scheme (MCS) level for the MS using the selected channel information; and transmitting the determined power level and MCS level to the MS.

### PRIORITY

This application claims the benefit under 35 U.S.C. § 119 of an application filed in the Korean Intellectual Property Office on Nov. 2, 2005 and assigned Serial No. 2005-104550, the entire contents of which are incorporated herein by reference.

### BACKGROUND OF THE INVENTION

1. Field of the Invention

The present invention relates generally to a wireless communication system, and in particular, to an apparatus and method for efficiently controlling an uplink load in a wireless communication system.

2. Description of the Related Art

Generally, performance and capacity of a wireless communication system are limited by such wireless propagation channel characteristics as inter/intra-cell co-channel interference, path loss, and multi-pass fading. There are power control, channel coding, rake reception, and antenna diversity technologies for compensating for the limited performance and capacity.

In a cellular wireless communication system, a plurality of mobile stations (MSs) located in one cell perform wireless communication with a base station (BS) managing the cell. Therefore, the BS receives uplink signals from each of the MSs. In this case, the signal transmitted by a particular MS may function as an interference signal component of the signal transmitted by another MS. If the signal transmitted by the particular MS is high in power, it will serve as a high-interference signal component.

Therefore, in the wireless communication system, uplink power control of the MS should be necessarily performed to allow the BS to stably receive signals of the MSs.

Generally, in the cellular wireless mobile communication system using Code Division Multiple Access (CDMA), the BS performs uplink power control of the MS using a Rise-Over-Thermal (ROT). The term “ROT” refers to a Received Signal Strength Indicator (RSSI) due to an increase in traffic, and the BS can analyze an uplink loading situation depending on the ROT. The ROT can be expressed as Equation (1):

$$ROT = \frac{N S + η}{η} = \frac{N S}{η} + 1 \qquad ( 1 )$$

As shown in Equation (1), the ROT is defined on the assumption that when there are multiple cells, one cell is interference-free from neighbor cells, N MSs are using the same service, and an uplink signal from each of the N MSs is perfectly power-controlled by a signal S. That is, the ROT shown in Equation (1) is given when interference from other cells is ignored, there are N users of the same type, and a signal from each of the users undergoes perfect power control by a signal S before it is received at the BS.

In Equation (1), η denotes thermal noise power. In the foregoing situation, if all MSs located in the cell are power-controlled at a required signal-to-interference ratio (Ec/Io)_{req}, the (Ec/Io)_{req} can be expressed as Equation (2):

$$\begin{matrix}{( \frac{{E}_{c}}{{I}_{0}} )}_{req} = \frac{S}{( N - 1 ) S + η} \\ ≅ \frac{S}{N S + η}\end{matrix} \qquad ( 2 )$$

In Equation (2), received power S of each MS can be expressed as Equation (3):

$$\begin{matrix}S = {( {E}_{c} \text{/} {I}_{0} )}_{req} ( N S + η ) \\ = \frac{{η ( {E}_{c} \text{/} {I}_{0} )}_{req}}{1 - {N ( {E}_{c} \text{/} {I}_{0} )}_{req}}\end{matrix} \qquad ( 3 )$$

From Equation (3), the ROT defined in Equation (1) can be rewritten as Equation (4):

$$\begin{matrix}ROT = \frac{N S}{η} + 1 \\ = \frac{N}{η} \cdot \frac{{η ( {E}_{c} \text{/} {I}_{0} )}_{req}}{1 - {N ( {E}_{c} \text{/} {I}_{0} )}_{req}} \\ = \frac{1}{1 - {N ( {E}_{c} \text{/} {I}_{0} )}_{req}}\end{matrix} \qquad ( 4 )$$

Next, using Equation (4), the pole capacity indicating the theoretical maximum uplink capacity in the cell environment can be calculated according to Equation (5) assuming ideal power control is performed and there is no thermal noise.

$${N}_{max} = \frac{1}{{( \frac{{E}_{c}}{{I}_{0}} )}_{req}} \qquad ( 5 )$$

Therefore, depending on Equation (5), the ROT can be expressed as Equation (6):

$$ROT = \frac{1}{1 - N / {N}_{max}} \qquad ( 6 )$$

FIG. 1 is a graph illustrating a change in ROT with respect to an increase in the uplink traffic in a general CMDA communication system.

As shown in FIG. 1, the ROT means a factor, i.e. system load, indicating the current load in the pole capacity of the system. Therefore, for stability of the system, a BS controls the uplink load on the basis of the ROT. With reference to FIGS. 2A and 2B, a description will now be made of an uplink load control process based on the ROT.

FIG. 2A is a flowchart and FIG. 2B is a diagram illustrating an uplink load control process in a general wireless communication system.

Referring to FIG. 2A, in a general uplink load control method, a BS first measures the total received power for a “silence” period where an MS transmits no signal. If a “non-silence” period has arrived, the BS measures the total received power for the “non-silence” period in step 201, and calculates ROT by comparing the total received power for the “silence” period with the total received power for the “non-silence” period in step 203.

The BS compares the calculated ROT with a predetermined threshold RoT_threshold in step 205. If the ROT is higher than the threshold RoT_threshold, the BS broadcasts Reverse Activity Bit (RAB)=1 in step 207. However, if the ROT is lower than the threshold RoT_threshold, the BS broadcasts RAB=0 in steps 209 and 211.

RAB=0 means that an MS can transmit data at a high rate as compared with the current rate, and RAB=1 means that the MS can transmit data at a low rate as compared with the current rate.

In order to accurately measure the ROT, signaling not only by the serving BS but also by neighbor BSs should be interrupted for the “silence” period as shown in FIG. 2B. Therefore, in the conventional wireless communication system, it is hard to calculate the ROT accurately.

In sum, after measuring the ROT, the BS broadcasts the measured ROT to each MS, and upon receipt of the measured ROT, the MS determines a data rate and transmission power according to the received ROT.

However, in the conventional wireless mobile communication system, the BS measures the thermal noise power η in a no-call state where all MSs periodically stop transmission for a predetermined time, and measures ROT in a normal call state. That is, the conventional MSs cannot transmit uplink signals to the BS even for a very short time. In addition, the method for controlling uplink load using the ROT index cannot be applied to a multi-carrier communication system.

Therefore, there is a need for a scheme capable of securing system stability in controlling uplink load in a wireless communication system, of efficiently controlling the uplink load, and of controlling the uplink load even in the multi-carrier communication system.

### SUMMARY OF THE INVENTION

It is, therefore, an object of the present invention to provide an apparatus and method for stably controlling an uplink load in a wireless mobile communication system.

It is another object of the present invention to provide a condition for preventing a reduction in system capacity and securing stable system link performance in a wireless mobile communication system, and a power control apparatus and method according thereto.

It is further another object of the present invention to provide an apparatus and method for controlling an uplink load using channel quality information of an MS managed by each BS in a wireless mobile communication system.

According to one aspect of the present invention, there is provided a method for controlling uplink power in a wireless communication system. The method includes receiving downlink channel information from a mobile station (MS); measuring uplink channel information of the MS; selecting channel information having a lower value from among the forward channel information and the uplink channel information; determining a power level and a Modulation and Coding Scheme (MCS) level for the MS using the selected channel information; and transmitting the determined power level and MCS level to the MS.

According to another aspect of the present invention, there is provided a method for controlling uplink power in a wireless communication system. The method includes receiving downlink channel information from a mobile station (MS), and measuring uplink channel information for the MS; comparing the downlink channel information with the uplink channel information; transmitting information with Reverse Activity Bit (RAB) set to 1 to the MS, if the downlink channel information is lower in level than the uplink channel; and transmitting information with RAB set to 0 to the MS, if the downlink channel information is higher in level than the uplink channel.

According to a further aspect of the present invention, there is provided a 30 base station (BS) apparatus for controlling uplink power in a wireless communication system. The BS apparatus includes a feedback information receiver for receiving downlink channel information from a mobile station (MS); an uplink Carrier-to-Interference ratio (C/I) measurer for measuring uplink channel information of the BS for the MS; a C/I level comparator for receiving the downlink channel information from the feedback information receiver and the uplink channel information from the uplink C/I measurer, and selecting channel information for power controlling by comparing the received channel information; and a power calculator for determining a power level and a Modulation and Coding Scheme (MCS) level for the MS according to the channel information selected by the C/I level comparator.

### BRIEF DESCRIPTION OF THE DRAWINGS

The above and other objects, features and advantages of the present invention will become more apparent from the following detailed description when taken in conjunction with the accompanying drawings in which:

FIG. 1 is a graph illustrating a change in ROT with respect to an increase in the uplink traffic in a general CMDA communication system;

FIG. 2A is a flowchart of an uplink load control process in a general wireless communication system;

FIG. 2B is a diagram illustrating an uplink load control process in a general wireless communication system;

FIG. 3 is a diagram illustrating a path loss that an MS suffers according to the present invention;

FIG. 4 is a diagram illustrating a structure of an apparatus for controlling an uplink load according to the present invention;

FIG. 5 is a diagram illustrating an exemplary uplink load control method according to the present invention; and

FIG. 6 is a diagram illustrating another exemplary uplink power control method according to the present invention.

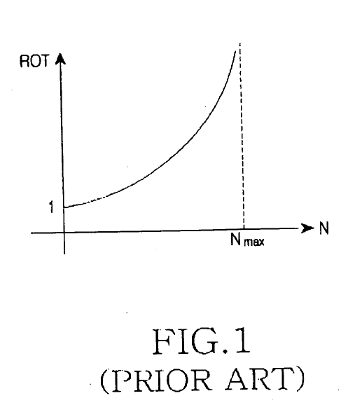

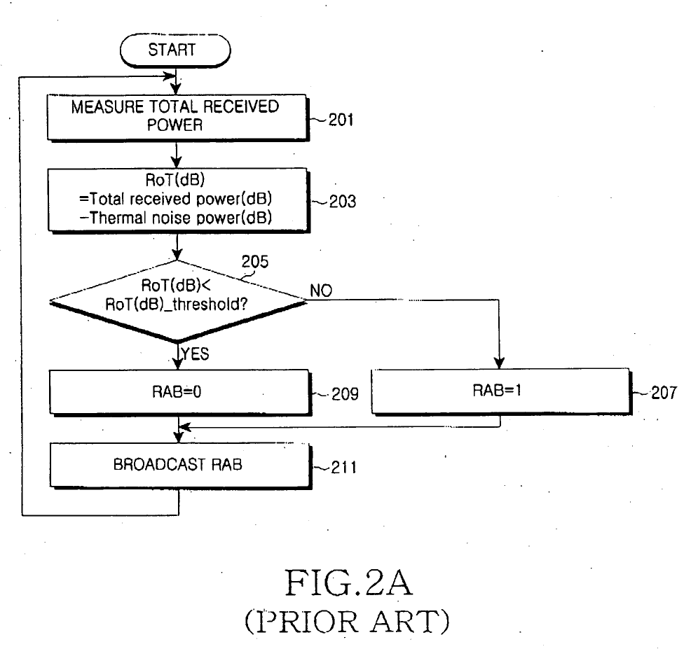

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides a scheme for minimizing interference to neighbor cells by allowing a BS to efficiently control an uplink load in a wireless mobile communication system. In particular, the present invention provides an apparatus and method for efficiently controlling an uplink load in a multi-carrier communication system.

Generally, there is a high possibility that the power transmitted by an MS located in the cell boundary will serve as interference to neighbor BSs. In particular, when the MS uses maximum power or power higher than a predetermined level, link performance with the corresponding BS improves as a Carrier-to-Interference ratio (C/I) of the corresponding serving BS increases. However, link performances of neighbor BSs suffer from deterioration as an increase in the interference reduces the C/I. This causes a decrease in the total capacity of the communication system.

Therefore, the present invention provides a condition for preventing a reduction in the system capacity, securing stable system link performance, and a power control method according thereto. In addition, the present invention provides an apparatus and method for controlling an uplink load using Channel Quality Information (CQI) of an MS managed by each BS without measurement of Rise-Over-Thermal (ROT) and additional increase in calculation load. Herein, the term “ROT” refers to a Received Signal Strength Indicator (RSSI) due to an increase in traffic.

To this end, the present invention will be applied to the system with a multi-cell structure, in which a particular sub-channel used in one cell is reused in adjacent cells. For example, Portable Internet (or Wireless Broadband (WiBro)) using 2.3 GHz band can use a Band-Adaptive Modulation and Coding (Band-AMC) scheme. The Band-AMC scheme applies a high-coding efficiency modulation technique for the high-quality received signal, thereby transmitting/receiving high-capacity data at high speed.

If one cell uses the Band-AMC scheme, sub-channels in different bands are allocated to MSs, so there is no interference between the MSs. However, when neighbor cells use the same sub-channels in the same band, signals of MSs using the sub-channels may serve as interference to each other.

In the current Portable Internet standard, there is no definition of an interval where data is not transmitted/received. Therefore, the BS cannot use the method for performing power control using the ROT index, as described in the Related Art section.

Therefore, the present invention provides an apparatus and method for performing power control using CQI of the MS.

A description of the present invention will first be made for a simple 2-cell system, and then extended to the generalized system. In addition, as described above, it will be assumed that because all MSs in the cell are allocated sub-channels in different bands, there is no interference between MSs in the same cell and there is interference between MSs using the same sub-channels in the same band in the neighbor cells. A description will now be made of the condition for securing stable link performance of the system according the present invention.

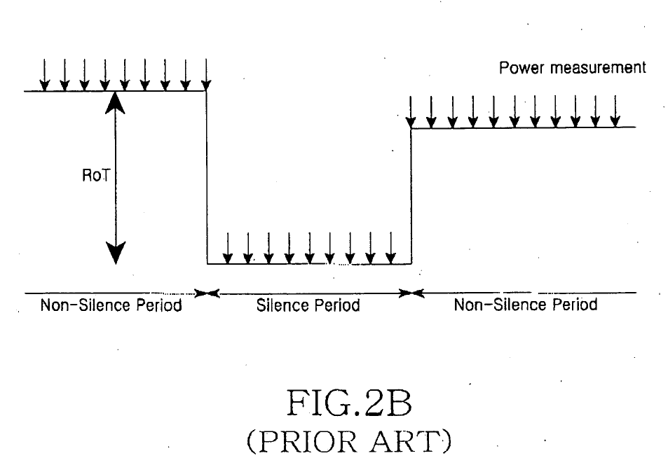

With reference to FIG. 3, a description will now be made of the conditions for securing stable link performance of the system.

As illustrated in FIG. 3, there are two cells Cell#0 and Cell#1, each having one BS 300 and 350, and MSs 302 and 352 which use the same sub-channels are located in the cells one by one. In FIG. 3, Lᵢⱼ denotes a path loss of an MS belonging to an i^{th} BS for a j^{th} BS. The path loss includes an antenna gain.

In FIG. 3, if transmission powers of MS 302 and MS 352 are denoted by P_{M0} and P_{M1}, C/Is of the signals received from BS 300 of the Cell#0 and BS 350 of the Cell#1 are denoted by Y_{B0} and Y_{B1}, and noise (for example, Additive White Gaussian Noise (AWGN)) is denoted by h, then each C/I can be expressed as Equation (7):

$$\begin{matrix}{γ}_{B 0} = \frac{{P}_{M 0} {L}_{00}}{{P}_{M 1} {L}_{10} + η} \\ {γ}_{B 1} = \frac{{P}_{M 1} {L}_{11}}{{P}_{M 0} {L}_{01} + η}\end{matrix} \qquad ( 7 )$$

In Equation (7), P_{M0} denotes power transmitted by MS 302, P_{M1} denotes power transmitted by MS 352, η denotes thermal noise power, L₀₀ denotes a path loss of MS 302 belonging to BS 300 for BS 300, L₀₁ denotes a path loss of MS 302 belonging to BS 300 for BS 350, L₁₀ denotes a path loss of MS 352 belonging to BS 350 for BS 300, and L₁₁ denotes a path loss of MS 352 belonging to BS 350 for BS 350.

If Equation (7) is developed for the powers P_{M0} and P_{M1} transmitted by MSs 302 and 352, it can be expressed as a simultaneous linear equation with two variables as shown in Equation (8) below.

$$\begin{matrix}{L}_{00} {P}_{M 0} - {γ}_{B 0} {L}_{10} {P}_{M 1} = {γ}_{B 0} η \\ - {γ}_{B 1} {L}_{01} {P}_{M 0} + {L}_{11} {P}_{M 1} = {γ}_{B 1} η\end{matrix} \qquad ( 8 )$$

The condition where transmission powers for MSs 302 and 352 are higher than 0 and they do not blow up can be expressed as Equation (9) below. Equation (9) can be rewritten as required C/Is of the MSs as shown in Equation (10) below.

$$\begin{matrix}{L}_{00} {L}_{11} - {γ}_{B 0} {γ}_{B 1} {L}_{10} {L}_{01} > 0 & ( 9 ) \\ {γ}_{B 0} {γ}_{B 1} < \frac{{L}_{00}}{{L}_{01}} \cdot \frac{{L}_{11}}{{L}_{10}} & ( 10 )\end{matrix}$$

If the condition of Equation (11) below is assigned to an MS in an i^{th} cell as a sufficient condition satisfying Equation (10), i.e. if each BS-received C/I, i.e. uplink C/I, is maintained below a ratio of a path loss to a cell to which the MS belongs to a path loss to a neighbor cell, then the system is stable.

Therefore, the BS allocates uplink power to an MS in an i^{th} cell such that the condition of Equation (11) is satisfied, and determines an uplink transmission data rate and then provides the corresponding information to the MS.

$${γ}_{B i} < \frac{{L}_{i i}}{{L}_{i j}} for all i \qquad ( 11 )$$

In other words, Equation (11) shows the scope of the C/I required by an MS, and if the BS controls the required C/I such that it is satisfied below a ratio of a path loss to the home cell to a path loss to the neighbor cell, the BS can secure system stability by minimizing the system load ratio.

As described above, a description has been made of the generalized case where neighbor BSs form a chain on the assumption that each BS has only one neighbor BS affecting the BS itself. Hereinafter, a description will be made of the case where the number of BSs is 3 and each BS serves as a neighbor BS to each other. That is, a description will be made of the case where one BS affects more than one BS.

The generalized case where the number of BSs affected by a particular BS is 2 (N=2) can be expressed as Equation (12):

$$[ \begin{matrix}\frac{{L}_{00}}{{γ}_{B 0}} & - {L}_{10} & - {L}_{20} \\ - {L}_{01} & \frac{{L}_{11}}{{γ}_{B 1}} & - {L}_{21} \\ - {L}_{02} & - {L}_{12} & \frac{- {L}_{22}}{{γ}_{B 2}}\end{matrix} ] [ \begin{matrix}{P}_{M 0} \\ {P}_{M 1} \\ {P}_{M 2}\end{matrix} ] = [ \begin{matrix}η \\ η \\ η\end{matrix} ] \qquad ( 12 )$$

After Equation (12) is developed for the P_{M0}, P_{M1} and P_{M2}, the stability condition where the transmission powers P_{M0}, P_{M1} and P_{M2} diverge to ∝ can be defined as Equation (13):

$$\frac{{L}_{01} {L}_{10} {L}_{22}}{{γ}_{B 2}} + \frac{{L}_{12} {L}_{21} {L}_{00}}{{γ}_{B 0}} + \frac{{L}_{02} {L}_{20} {L}_{11}}{{γ}_{B 1}} + {L}_{10} {L}_{21} {L}_{02} + {L}_{01} {L}_{12} {L}_{20} - \frac{{L}_{00} {L}_{11} {L}_{22}}{{γ}_{B 0} {γ}_{B 1} {γ}_{B 2}} < 0 \qquad ( 13 )$$

If

$$\frac{{L}_{i j}}{{γ}_{B i}} = {\sum }_{j \neq i} {L}_{i j}$$

is set for Equation (13), Equation (13) can be rewritten as Equation (14):
L₀₁L₁₀(L₂₀L₂₁)+L₁₂L₂₁(L₀₁L₀₂)+L₀₂L₂₀(L₁₀L₁₂)+L₁₀L₂₁L₀₂+L₀₁L₁₂L₂₀−(L₂₀+L₂₁)(L₀₁L₀₂)(L₁₀L₁₂)=0 (14)

Equation (14) means that if the condition of Equation (15) below is assigned for a user of an i^{th} BS, i.e. if a received (uplink) C/I of a BS in each cell is set lower than a ratio of its path loss to a sum of path losses to neighbor cells, the system is stable.

Therefore, the BS allocates uplink power to an MS in an i^{th} cell such that the condition of Equation (15) is satisfied, and determines an uplink transmission data rate and then provides the corresponding information to the MS.

$${γ}_{B i} < \frac{{L}_{i i}}{{\sum }_{j \neq i} {L}_{i j}} \qquad ( 15 )$$

Equation (15) means that if a C/I required by an MS in each cell is set lower than a ratio of a path loss of the home cell to a sum of path losses to neighbor cells, the system is stable.

In order to generalize the foregoing results, it will be assumed that the number of cells considered in the system is not limited to 2, but extended to N. Here, it would be obvious that the notations of other cases correspond to those of the foregoing results.

First, the number of cells is defined as N. Therefore, a required C/I, i.e. Y_{Bi}, of an MS of an i^{th} BS can be expressed as Equation (16):

$${γ}_{B i} = \frac{{P}_{M i} {L}_{i i}}{{\sum }_{k = 1 , k \neq i}^{N} {P}_{M k} {L}_{k i} + η} \qquad ( 16 )$$

In Equation (16), P_{Mi} denotes power transmitted by an MS belonging to an i^{th} BS, and η denotes thermal noise power.

Next, for Equation (16), a simultaneous linear equation with N variables can be given as Equation (17):

$$\frac{{L}_{i i}}{{γ}_{B i}} {P}_{M i} - {\sum }_{k \neq i} {L}_{k i} {P}_{B k} = η \\ [ \begin{matrix}\frac{{L}_{00}}{{γ}_{B 0}} & - {L}_{10} & - {L}_{20} & ⋯ & - {L}_{N 0} \\ - {L}_{01} & \frac{{L}_{11}}{{γ}_{B 0}} & - {L}_{21} & ⋯ & - {L}_{N 1} \\ ⋮ & ⋮ & ⋮ & ⋰ & ⋮ \\ - {L}_{0 N} & - {L}_{1 N} & - {L}_{2 N} & ⋯ & \frac{{L}_{N N}}{{γ}_{B N}}\end{matrix} ] [ \begin{matrix}{P}_{M 0} \\ {P}_{M 1} \\ ⋮ \\ {P}_{M N}\end{matrix} ] = [ \begin{matrix}η \\ η \\ ⋮ \\ η\end{matrix} ] \qquad ( 17 )$$

That is, as described above, it means that if Equation (18) below is satisfied for each MS of an i^{th} BS, i.e. if a received (uplink) C/I of a BS in each cell is set lower than a ratio of its path loss to a sum of path losses to neighbor cells, the system is stable.

$${γ}_{B i} < \frac{{L}_{i i}}{{\sum }_{j \neq i} {L}_{i j}} \qquad ( 18 )$$

Equation (18) means that if a C/I required by an MS in each cell is set lower than a ratio of a path loss to the home cell to a sum of path losses to neighbor cells, the system is stable.

For each of the foregoing cases, a received C/I of each MS is calculated as follows.

First, a description will be made of the case where there are 2 cells.

Because transmission power of each BS is generally constant, it is assumed that P_{B0}=P_{B1}. For the 2-cell system, a received C/I of each MS can be expressed as Equation (19):

$$\begin{matrix}{γ}_{M 0} = \frac{{P}_{B 0} {L}_{00}}{{P}_{B 1} {L}_{01} + η} \approx \frac{{L}_{00}}{{L}_{01}} \\ {γ}_{M 1} = \frac{{P}_{B 1} {L}_{11}}{{P}_{B 0} {L}_{10} + η} \approx \frac{{L}_{11}}{{L}_{10}}\end{matrix} \qquad ( 19 )$$

In Equation (19), γ_{M0} and γ_{M1} denote a received C/I of each MS, P_{Bi} denotes power transmitted by an MS belonging to an i^{th} BS, and η denotes thermal noise power.

Next, a description will be made of the general system having a plurality of cells. For the general system, a received C/I of each MS can be expressed as Equation (20):

$${γ}_{M i} \approx \frac{{L}_{i i}}{{\sum }_{j \neq i} {L}_{i j}} \qquad ( 20 )$$

In Equation (20), γ_{Mi} denotes a received C/I of an i^{th} MS, and Lᵢⱼ denotes a path loss of an MS belonging to an i^{th} BS for a j^{th} BS.

Therefore, from the foregoing definitions, the condition where the system is not overloaded can be given as Equation (21):
γ_{Bi}<γ_{Mi} (21)

In Equation (21), Y_{Bi} denotes a received (uplink) C/I of an i^{th} BS, and γ_{Mi} denotes a received (downlink) C/I of an i^{th} MS.

As shown in Equation (21), the condition for stabilizing the system performance means that a received (downlink) C/I of an MS managed by the corresponding BS should be higher than a received (uplink) C/I of the BS.

Therefore, in order to control the uplink load in the multi-carrier system, it is possible to use the foregoing information instead of measuring the ROT as done in the prior art. With reference to the accompanying drawings, a description will now be made of exemplary operations of efficiently controlling the uplink load using the condition shown in Equation (21) according to the present invention.

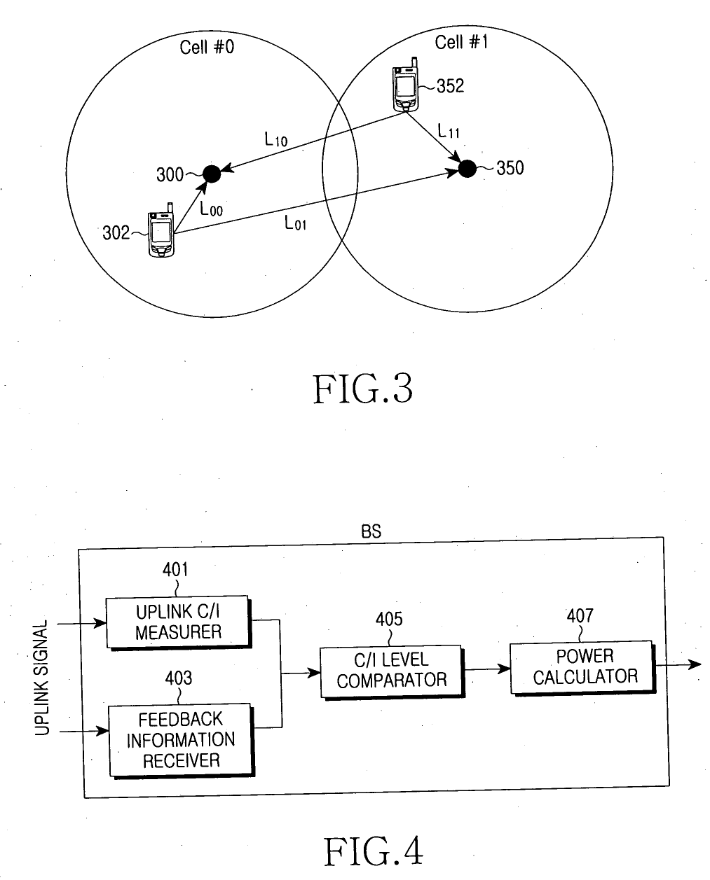

FIG. 4 is a diagram schematically illustrating a structure of an apparatus for controlling an uplink load according to an embodiment of the present invention.

Referring to FIG. 4, a BS for controlling an uplink load according to the present invention includes an uplink C/I measurer 401, a feedback information receiver 403, a C/I level comparator 405, and a power calculator 407.

If a particular MS measures a downlink C/I and transmits the measured downlink C/I to a BS, the BS receives the measured downlink C/I. Here, the feedback information receiver 403 receives the measured downlink C/I fed back from the MS, and outputs the received downlink C/I to the C/I level comparator 405. The uplink C/I measurer 401 measures an uplink C/I of the BS, and outputs the measured uplink C/I to the C/I level comparator 405. Preferably, the feedback information receiver 403 receives the downlink C/I using a dedicated channel, for example, a CQI channel (CQICH).

Then the C/I level comparator 405 receives the downlink C/I output from the feedback information receiver 403 and the uplink C/I output from the uplink C/I measurer 401, and compares the downlink C/I with the uplink C/I. Subsequently, the C/I level comparator 405 selects a lower C/I from among the downlink C/I and the uplink C/I through the comparison, and outputs the selected C/I to the power calculator 407.

The power calculator 407 determines a power level for a corresponding MS and a Modulation and Coding Selection (MCS) level for the MS based on the C/I selected by the C/I level comparator 405. The power calculator 407 transmits the determined information to the corresponding MS through a transmission apparatus.

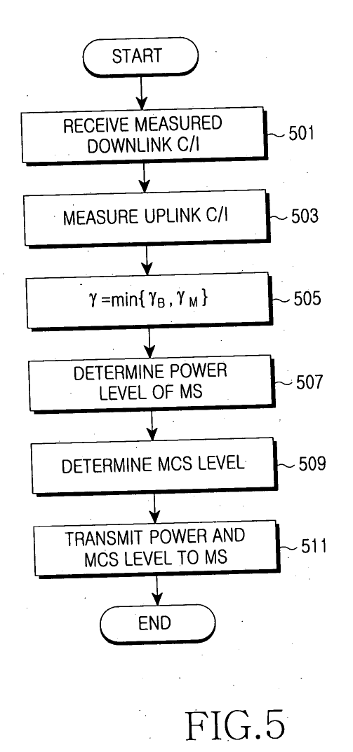

FIG. 5 is a diagram illustrating an exemplary uplink load control method according to an embodiment of the present invention.

Referring to FIG. 5, a particular MS measures its downlink C/I and feeds back the measured downlink C/I to a BS to which it belongs. Then, in step 501, the BS receives the measured downlink C/I fed back from the MS through a dedicated control channel, for example, CQICH. In step 503, the BS measures an uplink C/I for the MS. In step 505, the BS compares the downlink C/I received from the MS with its measured uplink C/I, and selects a lower C/I from among the two C/Is (γ=min{γ_{B},γ_{M}}).

In step 507, the BS determines a power level for the MS using the selected C/I. In step 509, the BS determines an MCS level for the MS. In step 511, the BS transmits the power level and MCS level determined for the MS, to the corresponding MS.

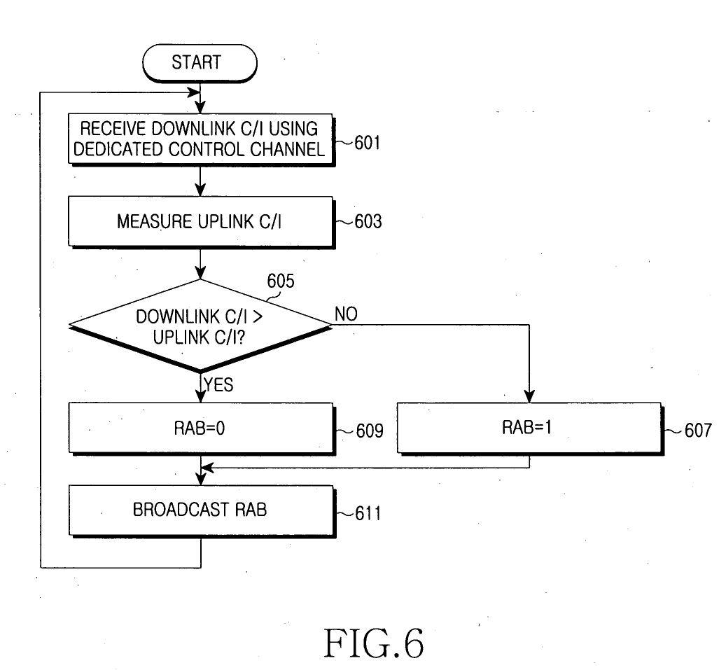

FIG. 6 is a diagram illustrating another exemplary uplink power control method according to an embodiment of the present invention.

Referring to FIG. 6, a particular MS measures its downlink C/I and feeds back the measured downlink C/I to a BS to which it belongs. Then, in step 601, the BS receives the measured downlink C/I fed back from the MS through a dedicated control channel, for example, CQICH. In step 603, the BS measures an uplink C/I for the MS.

In step 605, the BS compares the downlink C/I fed back from the MS with its measured uplink C/I. As a result of the comparison in step 605, if the downlink C/I is lower than or equal to the uplink C/I, the BS proceeds to step 607. If the downlink C/I is higher than the uplink C/I, the BS proceeds to step 609. The BS determines in step 605 whether the condition (γ_{Bi}<γ_{Mi}) shown in Equation (21) where the system is not overloaded is satisfied.

In step 607, if the uplink C/I is higher, the BS sets RAB=1 indicating non-satisfaction of the condition (γ_{Bi}<γ_{Mi}) of Equation (21), and broadcasts a RAB=1 to the corresponding MS in step 611. In step 609, if the downlink C/I is higher, the BS sets RAB=0 indicating satisfaction of the condition (γ_{Bi}<Y_{Mi}) of Equation (21), and broadcasts the RAB=0 to the corresponding MS in step 611. Herein, the RAB=0 information indicates the possibility of increasing transmission power of the MS, and RAB=1 information indicates the possibility of decreasing transmission power of the MS.

As can be understood from the foregoing description, the proposed uplink load control apparatus and method in a wireless communication system can efficiently control the uplink load using the CQI, i.e. the downlink C/I and the uplink C/I, without measurement of the ROT, additional information, and increase in the load calculation. The efficient uplink load control contributes to maintaining the stable performance of the wireless communication system. The power control using the downlink C/I and the uplink C/I can prevent a reduction in the system capacity, and secure stable link performance of the system.

While the invention has been shown and described with reference to a certain preferred embodiment thereof, it will be understood by those skilled in the art that various changes in form and details may be made therein without departing from the spirit and scope of the invention as further defined by the appended claims.

What is claimed is:

1. A method for controlling uplink power in a wireless communication system, the method comprising the steps of:
receiving downlink channel information from a mobile station (MS);
measuring uplink channel information of the MS;
selecting channel information having a lower value from among the downlink channel information and the uplink channel information;
determining a power level and a Modulation and Coding Selection (MCS) level for the MS using the selected channel information; and
transmitting the determined power level and MCS level to the MS.

2. The method of claim 1, wherein the channel information includes Channel Quality Information (CQI) of the MS.

3. The method of claim 1, wherein the downlink channel information includes a downlink Carrier-to-Interference ratio (C/I) measured and fed back by the MS.

4. The method of claim 1, wherein the uplink channel information includes an uplink C/I measured for the MS.

5. The method of claim 1, wherein the channel information is selected taking a system load into account according to
γ_{Bi}<γ_{Mi}
where γ_{Bi} denotes a received uplink C/I of an i^{th} base station (BS), and γ_{Mi} denotes a received downlink C/I of an i^{th} MS.

6. The method of claim 1, wherein the downlink channel information is received using a dedicated control channel.

7. The method of claim 6, wherein the dedicated control channel is a CQI channel (CQICH).

8. A method for controlling uplink power in a wireless communication system, the method comprising the steps of:
receiving downlink channel information from a mobile station (MS), and measuring uplink channel information for the MS;
comparing the downlink channel information with the uplink channel information;
transmitting information with a Reverse Activity Bit (RAB) set to 1 to the MS, if the downlink channel information is lower in level than the uplink channel; and
transmitting information with a RAB set to 0 to the MS, if the downlink channel information is higher in level than the uplink channel.

9. The method of claim 8, wherein the channel information includes Channel Quality Information (CQI) of the MS.

10. The method of claim 8, wherein the downlink channel information includes a downlink Carrier-to-Interference ratio (C/I) measured and fed back by the MS.

11. The method of claim 8, wherein the uplink channel information includes an uplink C/I measured for the MS.

12. The method of claim 8, wherein the channel information comparison comprises determining whether the following stability condition is satisfied taking a system load into account:
γ_{Bi}<γ_{Mi}
where γ_{Bi} denotes a received uplink C/I of an i^{th} base station (BS), and γ_{Mi} denotes a received downlink C/I of an i^{th} MS.

13. The method of claim 8, wherein if the downlink channel information is lower than the uplink channel information, it is determined that the stability condition of γ_{Bi}<γ_{Mi} is not satisfied.

14. The method of claim 8, wherein if the downlink channel information is higher than the uplink channel information, it is determined that the stability condition of γ_{Bi}<γ_{Mi} is satisfied.

15. The method of claim 8, wherein the downlink channel information is received using a dedicated control channel.

16. The method of claim 15, wherein the dedicated control channel is a CQI channel (CQICH).

17. A base station (BS) apparatus for controlling uplink power in a wireless communication system, comprising:
a feedback information receiver for receiving downlink channel information from a mobile station (MS);
an uplink Carrier-to-Interference ratio (C/I) measurer for measuring uplink channel information of the BS for the MS;
a C/I level comparator for receiving the downlink channel information from the feedback information receiver and the uplink channel information from the uplink C/I measurer, and selecting channel information for power controlling by comparing the received channel information; and
a power calculator for determining a power level and a Modulation and Coding Scheme (MCS) level for the MS according to the channel information selected by the C/I level comparator.

18. The BS apparatus of claim 17, wherein the channel information includes Channel Quality Information (CQI) of the MS.

19. The BS apparatus of claim 17, wherein the downlink channel information includes a downlink Carrier-to-Interference ratio (C/I) measured and fed back by the MS.

20. The BS apparatus of claim 17, wherein the uplink channel information includes an uplink C/I measured for the MS.

21. The BS apparatus of claim 17, wherein the C/I level comparator determines whether the following stability condition is satisfied taking a system load into account:
γ_{Bi}<γ_{Mi}
where γ_{Bi} denotes a received uplink C/I of an i^{th} BS, and γ_{Mi} denotes a received downlink C/I of an i^{th} MS.

22. The BS apparatus of claim 17, wherein if the downlink channel information is lower than the uplink channel information, the C/I level comparator determines that the stability condition of γ_{Bi}<γ_{Mi} is unsatisfied, where γ_{Bi} denotes a received uplink C/I of an i^{th} BS, and γ_{Mi} denotes a received downlink C/I of an i^{th} MS.

23. The BS apparatus of claim 17, wherein if the downlink channel information is higher than the uplink channel information, the C/I level comparator determines that the stability condition of γ_{Bi}<γ_{Mi} is satisfied, where γ_{Bi} denotes a received uplink C/I of an i^{th} BS, and γ_{Mi} denotes a received downlink C/I of an i^{th} MS.

24. The BS apparatus of claim 17, wherein the feedback information receiver receives the downlink channel information using a dedicated control channel.

25. The BS apparatus of claim 24, wherein the dedicated control channel is a CQI channel (CQICH).
